(19) United States
(12) Patent Application Publication
(10) Pub. No.: US 2026/0211748 A1
(43) Pub. Date: Jul. 23, 2026

(54) AUTO SCALING METHOD BASED ON CLOUD MANAGEMENT PLATFORM AND CLOUD MANAGEMENT PLATFORM

(71) Applicant: Huawei Cloud Computing Technologies Co., Ltd., Guizhou (CN)

(72) Inventors: Lei Guo, Toronto (CA); Zain Us Sami Ahmed Ansari, Toronto (CA); Javad Rahimipour Anaraki, Toronto (CA); Basil Y O Alkhatib, Toronto (CA); Jiawei Zhang, Hangzhou (CN); Hao Zhang, Shenzhen (CN)

(73) Assignee: Huawei Cloud Computing Technologies Co., Ltd., Guizhou (CN)

(21) Appl. No.: 19/572,276

(22) Filed: Mar. 19, 2026

Related U.S. Application Data
(63) Continuation of application No. PCT/CN2024/119560, filed on Sep. 19, 2024.

(30) Foreign Application Priority Data
Sep. 20, 2023 (CN) 202311224341.2
Jan. 9, 2024 (CN) 202410032231.4

(51) Int. Cl. G06F 9/50

(52) U.S. Cl. CPC G06F 9/5083

(57) ABSTRACT

An auto scaling method including: when the tenant needs to complete auto scaling for a scaling group of the tenant, the cloud management platform may receive, through a network interface, an auto scaling formula that is input by the tenant for the scaling group. Then, the cloud management platform may obtain a current load indicator of the scaling group, and substitute the current load indicator of the scaling group into the variable that indicates the current load of the scaling group and that is in the auto scaling formula, to obtain a target capacity of the scaling group. Finally, the cloud management platform may adjust a quantity of cloud instances included in the scaling group, until a capacity of an adjusted scaling group matches the target capacity of the scaling group.

### CROSS-REFERENCE TO RELATED APPLICATIONS

This application is a continuation of International Application No. PCT/CN2024/119560, filed on Sep. 19, 2024, which claims priority to Chinese Patent Application No. 202311224341.2, filed on Sep. 20, 2023, and Chinese Patent Application No. 202410032231.4, filed on Jan. 9, 2024. All of the aforementioned patent applications are hereby incorporated by reference in their entireties.

### TECHNICAL FIELD

Embodiments of this application relate to the field of cloud technologies, and in particular, to an auto scaling method based on a cloud management platform and a cloud management platform.

### BACKGROUND

An auto scaling (AS) technology is one of cornerstones of a cloud service system. This technology can increase or decrease, according to a policy, a quantity of cloud resources that provide cloud services for a tenant, expecting to meet service requirements of the tenant while controlling operation costs of the cloud service system by controlling the quantity of cloud resources.

The cloud service system in a related technology includes a cloud management platform and a scaling group created by the cloud management platform for the tenant, and the scaling group usually includes a cloud instance created by the cloud management platform for the tenant. When the scaling group runs an application of the tenant, the cloud management platform may determine a target capacity of the scaling group based on a capacity of the scaling group and a preset auto scaling policy. In this case, the cloud management platform may adjust a quantity of cloud instances in the scaling group until a capacity of an adjusted scaling group is equal to the target capacity.

In the foregoing process, the auto scaling policy is a black box for a user. In some embodiments, the user cannot determine how the cloud management platform obtains the target capacity of the scaling group, that is, the tenant cannot learn of a reason for adjustment performed by the cloud management platform for the scaling group. Consequently, trust of the tenant in the entire cloud service system is reduced, that is, reliability of the entire cloud service system is low.

### SUMMARY

Embodiments of this application provide an auto scaling method based on a cloud management platform and a cloud management platform, to improve trust of a tenant in an entire cloud service system, that is, improve reliability of the entire cloud service system.

A first aspect of embodiments of this application provides an auto scaling method based on a cloud management platform, where the cloud management platform is configured to manage an infrastructure that provides a cloud service, a scaling group of a tenant is disposed in the infrastructure, and the method includes:

When the tenant needs to perform, via the cloud management platform, auto scaling on the scaling group dedicated to the tenant, the cloud management platform may provide a network interface for the tenant. Therefore, the tenant may send, to the network interface, an auto scaling formula formulated by the tenant for the scaling group dedicated to the tenant, so that the cloud management platform receives, through the network interface, the auto scaling formula that is sent by the tenant and that is formulated by the tenant for the scaling group dedicated to the tenant. The auto scaling formula may include a variable that indicates current load of the scaling group, a target load indicator of the scaling group, and an operator between the variable and the target load indicator.

After obtaining the auto scaling formula formulated by the tenant for the scaling group of the tenant, the cloud management platform may collect information about the scaling group, to obtain a current load indicator of the scaling group, and substitute the current load indicator of the scaling group into a variable that indicates the current load indicator and that is in the auto scaling formula, to obtain a target capacity of the scaling group. After obtaining the target capacity of the scaling group, the cloud management platform may adjust a quantity of cloud instances included in the scaling group, until a capacity of an adjusted scaling group matches the target capacity of the scaling group.

It can be learned from the foregoing method that: When the tenant needs to complete auto scaling for the scaling group of the tenant, the cloud management platform may provide the network interface for the tenant, to receive, through the network interface, the auto scaling formula that is for the scaling group and that is input by the tenant. The auto scaling formula includes the variable that indicates the current load of the scaling group, the target load indicator of the scaling group, and the operator, and the variable that indicates the current load of the scaling group, the target load indicator of the scaling group, and the operator are used to determine the target capacity of the scaling group. Then, the cloud management platform may obtain the current load indicator of the scaling group, and substitute the current load indicator of the scaling group into the variable that indicates the current load of the scaling group and that is in the auto scaling formula, to obtain the target capacity of the scaling group. Finally, the cloud management platform may adjust the quantity of cloud instances included in the scaling group, until the capacity of the adjusted scaling group matches the target capacity of the scaling group. In this way, the cloud management platform may automatically complete auto scaling on the scaling group of the tenant according to the auto scaling formula formulated by the tenant. In the foregoing process, the auto scaling formula is formulated by the tenant for the scaling group of the tenant. In other words, content of the auto scaling formula is set by the tenant. Therefore, the cloud management platform determines the target capacity of the scaling group based on the content of the auto scaling formula. This process is determinable for the tenant, that is, the tenant may learn of a reason for auto scaling performed by the cloud management platform for the scaling group and how the cloud management platform performs auto scaling on the scaling group. An auto scaling operation performed by the cloud management platform on the scaling group can be explained to some extent, which can improve trust of the tenant in the entire cloud service system, and equivalently, improve reliability of the entire cloud service system.

In a possible implementation, the auto scaling formula of the scaling group includes a scale-up formula, and the target capacity of the scaling group is greater than a current capacity of the scaling group. In the foregoing manner, when the auto scaling formula is the scale-up formula, the target capacity that is of the scaling group and that is obtained according to the auto scaling formula is generally greater than the current capacity of the scaling group. In other words, a ratio of the current capacity of the scaling group to the target capacity of the scaling group is less than 1, indicating that the cloud management platform needs to scale up the scaling group. Therefore, the cloud management platform adds an additional cloud instance to the scaling group, to obtain the adjusted scaling group.

In a possible implementation, the auto scaling formula of the scaling group includes a scale-down formula, and the target capacity of the scaling group is less than a current capacity of the scaling group. In the foregoing implementation, when the auto scaling formula is the scale-down formula, the target capacity of the scaling group obtained according to the auto scaling formula is generally less than the current capacity of the scaling group. In other words, a ratio of the current capacity of the scaling group to the target capacity of the scaling group is greater than 1, indicating that the cloud management platform needs to scale up the scaling group. Therefore, the cloud management platform deletes an additional cloud instance to the scaling group, to obtain the adjusted scaling group.

In a possible implementation, that the cloud management platform obtains the current load indicator of the scaling group, substitutes the current load indicator into the variable, and determines the target capacity of the scaling group according to the auto scaling formula includes: The cloud management platform obtains the current load indicator of the scaling group, and substitutes the current load indicator into the variable, to obtain a ratio of the current capacity of the scaling group to the target capacity of the scaling group. The cloud management platform performs calculation based on the current capacity of the scaling group and the ratio, to obtain the target capacity of the scaling group. In the foregoing implementation, the cloud management platform may collect information about the scaling group, to obtain the current load indicator of the scaling group, substitute the current load indicator of the scaling group into the variable that indicates the current load indicator and that is in the auto scaling formula, and obtain the ratio of the current capacity of the scaling group to the target capacity of the scaling group according to the auto scaling formula. Then, the cloud management platform may perform calculation based on the current capacity of the scaling group and the ratio of the current capacity of the scaling group to the target capacity of the scaling group, to obtain the target capacity of the scaling group.

In a possible implementation, the current load indicator includes at least one of the following: current usage of a compute resource of a cloud instance in the scaling group, current usage of a storage resource of a cloud instance in the scaling group, current usage of a communication resource of a cloud instance in the scaling group, current request latency of a cloud instance in the scaling group, and a current quantity of requests of a cloud instance in the scaling group; and the target load indicator of the scaling group includes at least one of the following: target usage of a compute resource of a cloud instance in the scaling group, target usage of a storage resource of a cloud instance in the scaling group, target usage of a communication resource of a cloud instance in the scaling group, target request latency of a cloud instance in the scaling group, and a target quantity of requests of a cloud instance in the scaling group.

In a possible implementation, the current capacity of the scaling group includes at least one of the following: a current total quantity of compute resources of a cloud instance in the scaling group, a current total quantity of storage resources of a cloud instance in the scaling group, and a current total quantity of communication resources of a cloud instance in the scaling group; and the target load of the scaling group includes at least one of the following: a target total quantity of compute resources of a cloud instance in the scaling group, a target total quantity of storage resources of a cloud instance in the scaling group, and a target total quantity of communication resources of a cloud instance in the scaling group.

In a possible implementation, the cloud instance in the scaling group is any one of the following: a physical server, a virtual machine, a micro virtual machine, a container, or a bare metal server.

A second aspect of embodiments of this application provides a cloud management platform, where the cloud management platform is configured to manage an infrastructure that provides a cloud service, a scaling group of a tenant is disposed in the infrastructure, and the cloud management platform includes: A receiving module, configured to receive, through a network interface, an auto scaling formula that is input by the tenant for the scaling group, where the auto scaling formula includes a variable that indicates current load of the scaling group, a target load indicator of the scaling group, and an operator, and the variable, the target load indicator of the scaling group, and the operator are used to determine a target capacity of the scaling group; an obtaining module, configured to obtain a current load indicator of the scaling group, substitute the current load indicator into the variable, and determine the target capacity of the scaling group according to the auto scaling formula; and an adjustment module, configured to adjust the scaling group based on the target capacity, where a capacity of an adjusted scaling group matches the target capacity.

In a possible implementation, the auto scaling formula of the scaling group includes a scale-up formula, and the target capacity of the scaling group is greater than a current capacity of the scaling group.

In a possible implementation, the auto scaling formula of the scaling group includes a scale-down formula, and the target capacity of the scaling group is less than a current capacity of the scaling group.

In a possible implementation, the obtaining module is configured to: obtain the current load indicator of the scaling group, substitute the current load indicator into the variable, to obtain a ratio of the current capacity of the scaling group to the target capacity of the scaling group; and perform calculation based on the current capacity of the scaling group and the ratio, to obtain the target capacity of the scaling group.

In a possible implementation, the current load indicator includes at least one of the following: current usage of a compute resource of a cloud instance in the scaling group, current usage of a storage resource of a cloud instance in the scaling group, current usage of a communication resource of a cloud instance in the scaling group, current request latency of a cloud instance in the scaling group, and a current quantity of requests of a cloud instance in the scaling group; and the target load indicator of the scaling group includes at least one of the following: target usage of a compute resource of a cloud instance in the scaling group, target usage of a storage resource of a cloud instance in the scaling group, target usage of a communication resource of a cloud instance in the scaling group, target request latency of a cloud instance in the scaling group, and a target quantity of requests of a cloud instance in the scaling group.

In a possible implementation, the current capacity of the scaling group includes at least one of the following: a current total quantity of compute resources of a cloud instance in the scaling group, a current total quantity of storage resources of a cloud instance in the scaling group, and a current total quantity of communication resources of a cloud instance in the scaling group; and the target load of the scaling group includes at least one of the following: a target total quantity of compute resources of a cloud instance in the scaling group, a target total quantity of storage resources of a cloud instance in the scaling group, and a target total quantity of communication resources of a cloud instance in the scaling group.

In a possible implementation, the cloud instance in the scaling group is any one of the following: a physical server, a virtual machine, a micro virtual machine, a container, or a bare metal server.

A third aspect of embodiments of this application provides a compute device cluster. The compute device cluster includes at least one compute device, and each compute device includes a processor and a memory. The memory is configured to store instructions. The processor is configured to cause, according to the instructions, the compute device cluster to perform the method according to any one of the first aspect or the possible implementations of the first aspect.

A fourth aspect of embodiments of this application provides a computer storage medium. The computer storage medium stores one or more instructions. When the instructions are executed by one or more computers, the one or more computers are caused to perform the method according to any one of the first aspect or the possible implementations of the first aspect.

A fifth aspect of embodiments of this application provides a computer program product. The computer program product stores instructions, and when the instructions are executed by a computer, the computer is caused to perform the method according to any one of the first aspect or the possible implementations of the first aspect.

In embodiments of this application, when the tenant needs to complete auto scaling for the scaling group of the tenant, the cloud management platform may provide the network interface for the tenant, to receive, through the network interface, the auto scaling formula that is for the scaling group and that is input by the tenant. The auto scaling formula includes the variable that indicates the current load of the scaling group, the target load indicator of the scaling group, and the operator, and the variable that indicates the current load of the scaling group, the target load indicator of the scaling group, and the operator are used to determine the target capacity of the scaling group. Then, the cloud management platform may obtain the current load indicator of the scaling group, and substitute the current load indicator of the scaling group into the variable that indicates the current load of the scaling group and that is in the auto scaling formula, to obtain the target capacity of the scaling group. Finally, the cloud management platform may adjust the quantity of cloud instances included in the scaling group, until the capacity of the adjusted scaling group matches the target capacity of the scaling group. In this way, the cloud management platform may automatically complete auto scaling on the scaling group of the tenant according to the auto scaling formula formulated by the tenant. In the foregoing process, the auto scaling formula is formulated by the tenant for the scaling group of the tenant. In other words, content of the auto scaling formula is set by the tenant. Therefore, the cloud management platform determines the target capacity of the scaling group based on the content of the auto scaling formula. This process is determinable for the tenant, that is, the tenant may learn of a reason for auto scaling performed by the cloud management platform for the scaling group and how the cloud management platform performs auto scaling on the scaling group. An auto scaling operation performed by the cloud management platform on the scaling group can be explained to some extent, which can improve trust of the tenant in the entire cloud service system, and equivalently, improve reliability of the entire cloud service system.

### BRIEF DESCRIPTION OF DRAWINGS

FIG. 1 is a diagram of a structure of a cloud service system according to an embodiment of this application;

FIG. 2 is a schematic flowchart of an auto scaling method based on a cloud management platform according to an embodiment of this application;

FIG. 3 is a diagram of a tenant interface according to an embodiment of this application;

FIG. 4 is another diagram of a tenant interface according to an embodiment of this application;

FIG. 5 is a diagram of scaling up and scaling down according to an embodiment of this application;

FIG. 6 is another schematic flowchart of an auto scaling method based on a cloud management platform according to an embodiment of this application;

FIG. 7 is still another schematic flowchart of an auto scaling method based on a cloud management platform according to an embodiment of this application;

FIG. 8 is a diagram of a structure of a cloud management platform according to an embodiment of this application;

FIG. 9 is a diagram of a structure of a compute device according to an embodiment of this application;

FIG. 10 is a diagram of a structure of a compute device cluster according to an embodiment of this application; and

FIG. 11 is a diagram in which computer devices in a computer cluster are connected through a network according to an embodiment of this application.

### DESCRIPTION OF EMBODIMENTS

Embodiments of this application provide an auto scaling method based on a cloud management platform and a cloud management platform, to improve trust of a tenant in an entire cloud service system, that is, improve reliability of the entire cloud service system.

In this specification, the claims, and the accompanying drawings of this application, the terms “first”, “second”, and the like are intended to distinguish between similar objects but do not necessarily indicate a specific order or sequence. It should be understood that the terms used in such a way are interchangeable in proper circumstances, which is merely a discrimination manner used when objects having a same attribute are described in embodiments of this application. In addition, the terms “include”, “have”, and any other variants mean to cover a non-exclusive inclusion, so that a process, method, system, product, or device that includes a series of units is not necessarily limited to those units, but may include other units not expressly listed or inherent to such a process, method, product, or device.

An auto scaling technology is one of cornerstones of the cloud service system. This technology can increase or decrease, according to a policy, a quantity of cloud resources that provide cloud services for a tenant, expecting to meet service requirements of the tenant while controlling operation costs of the cloud service system by controlling the quantity of cloud resources.

The cloud service system in a related technology includes a cloud management platform and a scaling group created by the cloud management platform for the tenant, and the scaling group usually includes a cloud instance created by the cloud management platform for the tenant. When the scaling group runs an application of the tenant, the cloud management platform may determine a target capacity of the scaling group based on a capacity of the scaling group and a preset auto scaling policy. In this case, the cloud management platform may adjust a quantity of cloud instances in the scaling group until a capacity of an adjusted scaling group is equal to the target capacity. For example, it is assumed that the preset auto scaling policy includes a maximum capacity and a minimum capacity. After determining that the capacity of the scaling group is outside an interval formed by the maximum capacity and the minimum capacity, the cloud management platform may select a capacity in the interval as the target capacity, and increase or decrease cloud instances in the scaling group, to cause the capacity of the adjusted scaling group to be equal to the target capacity.

In the foregoing process, the auto scaling policy is a black box for a user. In some embodiments, the user cannot determine how the cloud management platform obtains the target capacity of the scaling group, that is, the tenant cannot learn of a reason for adjustment performed by the cloud management platform for the scaling group. Consequently, trust of the tenant in the entire cloud service system is reduced, that is, reliability of the entire cloud service system is low.

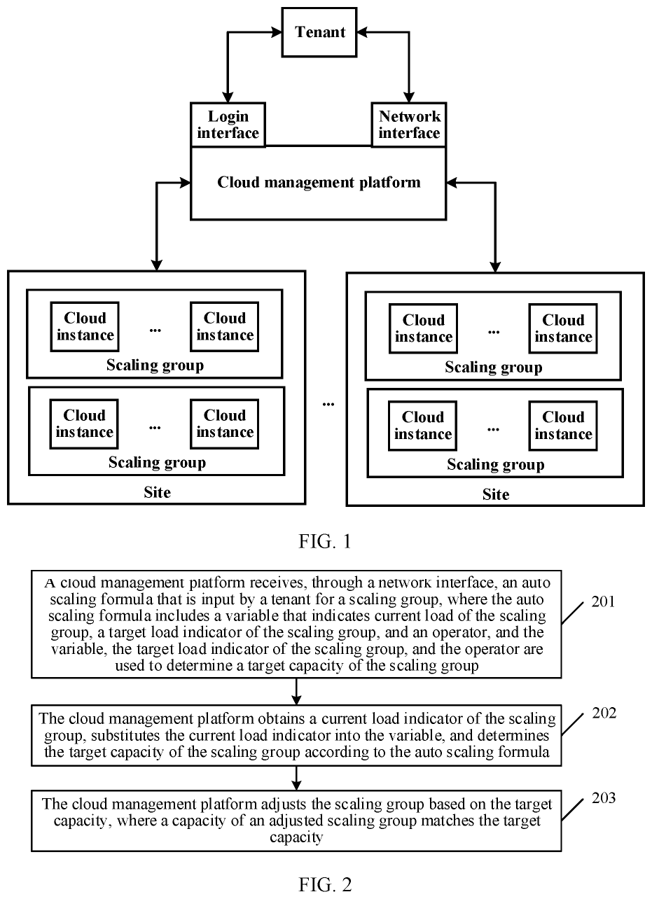

To resolve the foregoing problem, embodiments of this application provide an auto scaling method based on a cloud management platform. The method may be implemented through a cloud service system. FIG. 1 is a diagram of a structure of a cloud service system according to an embodiment of this application. As shown in FIG. 1, the cloud service system includes an infrastructure that can provide a cloud service and a cloud management platform that manages the infrastructure. The following separately describes the cloud management platform and the infrastructure.

The cloud management platform may perform coordinated management on all cloud instances in the entire cloud service system (for example, the cloud management platform may create a dedicated scaling group for a tenant, and cloud instances included in the scaling group are used to run an application of the tenant; or for another example, the cloud management platform may further adjust a quantity of cloud instances included in the scaling group of the tenant, to obtain an adjusted scaling group), or the cloud management platform may be open to a tenant outside the system, and respond to a request of the tenant. For example, the cloud management platform may provide various interfaces such as a login interface and a network interface for a client of a tenant (for example, a terminal device used by the tenant or a browser on the terminal device) to access. The cloud management platform may perform identity authentication on the client of the tenant through the login interface. After the identity authentication succeeds, the client of the tenant may be allowed to log in to the cloud management platform. For another example, the cloud management platform may further send a preset template to the client of the tenant through the network interface. Therefore, the client of the tenant may display the preset template to the tenant for viewing and using, so that the tenant formulates, on the client of the tenant, an auto scaling policy for the scaling group dedicated to the tenant, and sends the auto scaling policy to the cloud management platform through the network interface. For still another example, the cloud management platform may further allow, through the network interface, the tenant to send, to the cloud management platform through the client, an auto scaling formula (that is, the auto scaling policy) formulated by the tenant for the scaling group dedicated to the tenant. Because the auto scaling formula includes a variable that indicates current load of the scaling group, a target load indicator of the scaling group, and an operator between the variable and the target load indicator, the cloud management platform may obtain a current load indicator of the scaling group and substitute the current load indicator of scaling group into the auto scaling formula, to determine the target capacity of the scaling group. In this way, the cloud management platform may adjust the quantity of cloud instances in the scaling group until a capacity of the adjusted scaling group matches the target capacity.

The infrastructure includes the scaling group created by the cloud management platform for the tenant, and the scaling group may include one or more cloud instances. It should be noted that, for any cloud instance in the scaling group, the cloud instance may be presented in a plurality of manners. For example, the cloud instance may be a physical server specified by the cloud management platform. For another example, the cloud instance may alternatively be a virtual machine (VM) created on a physical server by the cloud management platform by using a virtualization technology. For another example, the cloud instance may alternatively be a container (docker) created on a physical server by the cloud management platform by using a virtualization technology. For another example, the cloud instance may alternatively be a micro virtual machine (microVM) created on a physical server by the cloud management platform by using a virtualization technology. For another example, the cloud instance may alternatively be a container (docker) created on a physical server by the cloud management platform by using a virtualization technology. For another example, the cloud instance may alternatively be a bare metal server specified by the cloud management platform.

Further, if the scaling group of the tenant includes a plurality of cloud instances, the plurality of cloud instances may be disposed at one or more sites, and the site may be presented in a plurality of forms. For example, the one or more sites may be a plurality of regions (region) in the infrastructure. For another example, the one or more sites may be a plurality of availability zones (availability zone) in the infrastructure. For still another example, the one or more sites may be at least one edge site and at least one central cloud site in the infrastructure.

It should be noted that, in embodiments of this application, the tenant may send, to the cloud management platform, the auto scaling formula formulated by the tenant for the scaling group, so that the cloud management platform calculates the target capacity of the scaling group according to the auto scaling formula, and then adjusts the scaling group of the tenant based on the target capacity, to obtain the adjusted scaling group. It can be learned that, in this case, the target capacity of the scaling group is obtained by the cloud management platform through calculation. If the tenant intends to protect data security of the tenant, the tenant (the client of the tenant) or a cloud instance of the tenant may calculate the target capacity of the scaling group according to the auto scaling formula, and then return the target capacity to the cloud management platform, so that the scaling group of the tenant is adjusted based on the target capacity. In this way, the adjusted scaling group is obtained. It can be learned that, in the two cases, the target capacity of the scaling group is no longer calculated by the cloud management platform. Therefore, the cloud management platform does not need to obtain the auto scaling policy formulated by the tenant, thereby ensuring the data security of the tenant.

It can be learned that there are three cases in the method provided in embodiments of this application. The following mainly describes a first case. FIG. 2 is a schematic flowchart of an auto scaling method based on a cloud management platform according to an embodiment of this application. As shown in FIG. 2, the method may be implemented by the cloud management platform in the cloud service system shown in FIG. 1. The cloud management platform is configured to manage an infrastructure that provides a cloud service, where the infrastructure includes a scaling group created by the cloud management platform for a tenant, and one or more cloud instances included in the scaling group are used to run an application of the tenant. The method includes the following operations.

201: The cloud management platform receives, through a network interface, an auto scaling formula that is input by the tenant for the scaling group, where the auto scaling formula includes a variable that indicates current load of the scaling group, a target load indicator of the scaling group, and an operator, and the variable, the target load indicator of the scaling group, and the operator are used to determine a target capacity of the scaling group.

In this embodiment, when the tenant needs to perform, via the cloud management platform, auto scaling on the scaling group dedicated to the tenant, the cloud management platform may provide the network interface (for example, an auto scaling policy input bar and a template display window on a tenant interface) for a client of the tenant. Therefore, the tenant may send, through the client to the network interface, the auto scaling formula formulated by the tenant for the scaling group dedicated to the tenant, so that the cloud management platform receives, through the network interface, the auto scaling formula that is formulated by the tenant for the scaling group dedicated to the tenant and that is sent by the client of the tenant.

It should be noted that an initial auto scaling formula formulated by the tenant for the scaling group dedicated to the tenant may also include a variable that indicates the current load of the scaling group, a variable that indicates target load of the scaling group, an operator between the variables, and the like. Because the target load indicator of the scaling group is usually also formulated by the tenant, the tenant may directly substitute the target load indicator of the scaling group into the initial auto scaling formula, to obtain the auto scaling formula formulated by the tenant for the scaling group dedicated to the tenant. The auto scaling formula may include the variable that indicates the current load of the scaling group, the target load indicator of the scaling group, the operator between the variable and the target load indicator, and the like.

The current load indicator of the scaling group may include one or more of current usage of compute resources (for example, a central processing unit, a graphics processing unit, and other resources) of all cloud instances in the scaling group, current usage of storage resources (for example, a memory, a hard disk, and other resources) of all cloud instances in the scaling group, current usage of communication resources (for example, network bandwidth and other resources) of all cloud instances in the scaling group, current request latency of all cloud instances in the scaling group, a current quantity of requests of all cloud instances in the scaling group, and the like. Similarly, the target load indicator of the scaling group may include one or more of target usage of compute resources of all cloud instances in the scaling group, target usage of storage resources of all cloud instances in the scaling group, target usage of communication resources of all cloud instances in the scaling group, target request latency of all cloud instances in the scaling group, a target quantity of requests of all cloud instances in the scaling group, and the like.

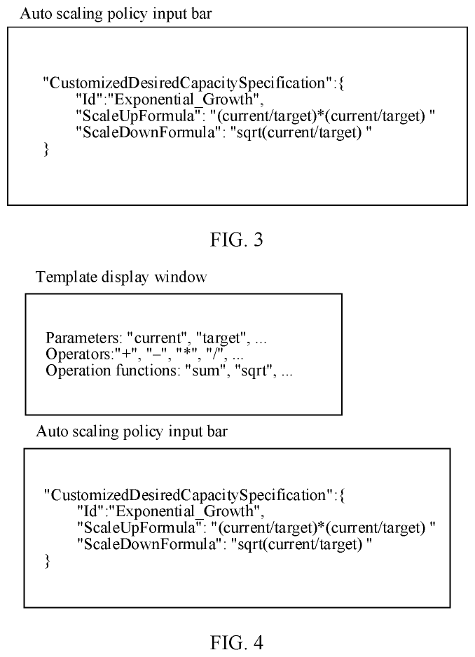

For example, as shown in FIG. 3 (FIG. 3 is a diagram of a tenant interface according to an embodiment of this application), when a tenant needs to formulate an auto scaling policy for a scaling group of the tenant, the tenant may first log in to a cloud management platform, and input, in an auto scaling formula input bar of the tenant interface provided by the cloud management platform, the following initial auto scaling formula formulated by the tenant for the scaling group of the tenant:

“CustomizedDesiredCapacitySpecification”:{

“Id”:“Exponential_Growth”,
“ScaleUpFormula”: “(current/target)*(current/target) ”
“ScaleDownFormula”: “sqrt(current/target) ”

}

It can be learned from the initial auto scaling formula customized by the tenant that the tenant expects the cloud management platform to complete capacity adjustment based on an exponential change when the cloud management platform scales up and scales down the scaling group. In addition, the tenant defines the initial auto scaling formula in the auto scaling formula. The formula includes a variable “current” and a variable “target”, where “current” represents current load of the scaling group, and “target” represents target load of the scaling group. The auto scaling formula includes operators such as a multiplication sign “*”, a division sign “/”, and “sqrt”. If the tenant also sets a target load indicator of the scaling group to 60%, the tenant can replace “target” with 60% to obtain a final auto scaling formula. In this way, the cloud management platform may receive, through the auto scaling formula input bar, the final auto scaling formula formulated by the tenant for the scaling group of the tenant.

In some embodiments, before the tenant sends the auto scaling formula to the cloud management platform, the tenant may customize the auto scaling formula in the following manner:

When the tenant needs to formulate the auto scaling formula for the scaling group of the tenant, the cloud management platform may provide a network interface for a client of the tenant, and the network interface may present preset formula templates to the tenant. These formula templates may include a plurality of preset variables and a plurality of preset operators. After browsing these formula templates, the tenant may select some variables (the variable that indicates the current load of the scaling group, the variable that indicates the target load of the scaling group, and the like) from the plurality of preset variables and the plurality of preset operators, and some operators/or some operation functions are used to establish a mathematical relationship between these variables, to generate the initial auto scaling formula customized by the tenant for the scaling group. In addition, the tenant may further customize the target load indicator of the scaling group, substitute the target load indicator of the scaling group into the variable that indicates the target load of the scaling group and that is in the initial auto scaling formula, to obtain the auto scaling formula customized by the tenant for the scaling group, and send, to the cloud management platform through the network interface, the auto scaling formula customized by the tenant for the scaling group.

It should be noted that the plurality of preset variables and the plurality of preset operators may be preset by the tenant, or may be preset by an administrator of the cloud management platform. This is not limited herein. Regardless of whether the variables and the operators are set by the tenant or the administrator, both the plurality of variables and the plurality of operators are set according to some rules agreed on by the tenant and the administrator. Therefore, both the client of the tenant and the cloud management platform can identify and transmit the plurality of variables and the plurality of operators.

For example, as shown in FIG. 4 (FIG. 4 is another diagram of a tenant interface according to an embodiment of this application, and FIG. 4 is drawn based on FIG. 3), after a tenant logs in to a cloud management platform, the cloud management platform may provide a template display window of the tenant interface for the tenant. The template display window displays a plurality of preset variables such as “current” and “target”, and further displays a plurality of preset operators such as “+”, “−”, “*”, “/”, “sum”, and “sqrt”. After browsing content displayed in the template display window, the tenant may select from the content, and input selected content such as “current”, “target”, “*”, “/”, and “sqrt” into an auto scaling policy input bar, to obtain, through edition, an initial auto scaling formula formulated by the tenant for the scaling group of the tenant, and substitute a target load indicator of the scaling group into the initial auto scaling formula, to obtain a final auto scaling formula formulated by the tenant for the scaling group of the tenant. In this way, the cloud management platform may receive, through the auto scaling formula input bar, the final auto scaling formula formulated by the tenant for the scaling group of the tenant.

It should be understood that the usage in this embodiment may be understood as usage at a current moment, usage at a future moment, or the like. In addition, the target usage in this embodiment may be understood as maximum usage set by a tenant, or the like. Similarly, the request latency in this embodiment may be understood as request latency at a current moment, request latency at a future moment, or the like, and the target request latency in this embodiment may be understood as maximum request latency set by a tenant, or the like. Similarly, the quantity of requests in this embodiment may be understood as a quantity of requests at a current moment, a quantity of requests at a future moment, or the like, and the target quantity of requests in this embodiment may be understood as a maximum quantity of requests set by a tenant, or the like.

It should be further understood that, in this embodiment, the example shown in FIG. 3 is described by using an example in which the formula in the auto scaling formula includes parameters, operators, and operation functions. In actual application, the formula in the auto scaling formula may include only a parameter and an operator, or the formula in the auto scaling formula may include only a parameter, an operation function, and the like. This is not limited herein.

202: The cloud management platform obtains the current load indicator of the scaling group, substitutes the current load indicator into the variable, and determines the target capacity of the scaling group according to the auto scaling formula.

After obtaining the auto scaling formula formulated by the tenant for the scaling group of the tenant, the cloud management platform may collect information about the scaling group, to obtain the current load indicator of the scaling group, and substitute the current load indicator of the scaling group into the variable that indicates the current load indicator and that is in the auto scaling formula, to obtain the target capacity of the scaling group. Generally, when the auto scaling formula is a scale-up formula, the target capacity that is of the scaling group and that is obtained according to the auto scaling formula is generally greater than a current capacity of the scaling group. When the auto scaling formula is a scale-down formula, the target capacity that is of the scaling group and that is obtained according to the auto scaling formula is generally less than the current capacity of the scaling group.

The current capacity of the scaling group may include one or more of a current total quantity of compute resources of all cloud instances in the scaling group, a current total quantity of storage resources of all cloud instances in the scaling group, a current total quantity of communication resources of all cloud instances in the scaling group, and the like. Similarly, the target load of the scaling group may include one or more of a target total quantity of compute resources of all cloud instances in the scaling group, a target total quantity of storage resources of all cloud instances in the scaling group, a target total quantity of communication resources of all cloud instances in the scaling group, and the like.

In some embodiments, the cloud management platform may obtain the target capacity of the scaling group in the following manner:

The cloud management platform may obtain the current load indicator of the scaling group, substitute the current load indicator of the scaling group into the variable that indicates the current load indicator and that is in the auto scaling formula, and obtain a ratio of the current capacity of the scaling group to the target capacity of the scaling group according to the auto scaling formula. Then, the cloud management platform may perform calculation based on the current capacity of the scaling group and the ratio of the current capacity of the scaling group to the target capacity of the scaling group, to obtain the target capacity of the scaling group.

The foregoing example is still used. It is assumed that a quantity of cloud instances in the scaling group is four, and a capacity of one cloud instance is considered as 1. Therefore, the current capacity of the scaling group is 4. The current load of the scaling group is 90%, and the target load of the scaling group is 60%. According to the auto scaling formula formulated by the tenant, the cloud management platform may perform the following calculation: (90%/60%)*(90%/60%)=2.25. In this case, 2.25 may be considered as the ratio of the target capacity of the scaling group to the current capacity of the scaling group. After obtaining that the ratio of the target capacity of the scaling group to the current capacity of the scaling group is 2.25, the cloud management platform may perform the following calculation: 2.25*4=9. In this case, the cloud management platform may determine that the target capacity of the scaling group is 9.

It should be understood that the current capacity in this embodiment may be understood as a capacity at a current moment, and the target capacity in this embodiment may be understood as an ideal capacity obtained by the cloud management platform based on a tenant requirement.

203: The cloud management platform adjusts the scaling group based on the target capacity, where a capacity of an adjusted scaling group matches the target capacity.

After obtaining the target capacity of the scaling group, the cloud management platform may adjust a quantity of cloud instances included in the scaling group, until the capacity of the adjusted scaling group matches the target capacity of the scaling group. Generally, if the ratio of the current capacity of the scaling group to the target capacity of the scaling group is less than 1, it indicates that the cloud management platform needs to scale up the scaling group, and the cloud management platform adds an additional cloud instance to the scaling group, to obtain the adjusted scaling group. If the ratio of the current capacity of the scaling group to the target capacity of the scaling group is greater than 1, it indicates that the cloud management platform needs to scale down the scaling group, and the cloud management platform reduces a part of cloud instances in the scaling group, to obtain the adjusted scaling group. In this case, the cloud management platform automatically completes, according to the auto scaling formula formulated by the tenant, auto scaling on the scaling group of the tenant (that is, perform scale-up and scale-down, where because a quantity of cloud instances in the adjusted scaling group increases or decreases compared with a quantity of cloud instances in an original scaling group, the capacity of the adjusted scaling group correspondingly increases or decreases compared with a capacity of the original scaling group).

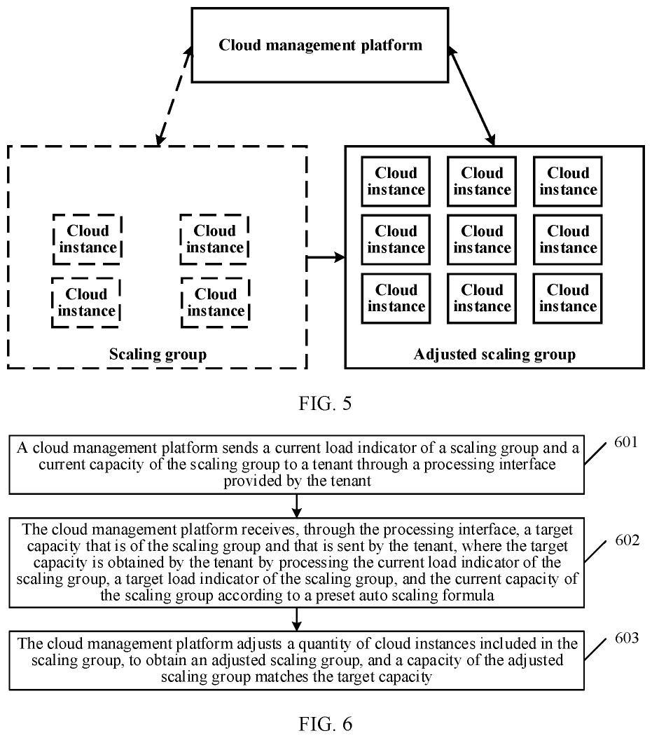

For example, as shown in FIG. 5 (FIG. 5 is a diagram of scaling up and scaling down according to an embodiment of this application, and FIG. 5 is drawn based on FIG. 4), after obtaining that the target capacity of the scaling group is 9, the cloud management platform may create five additional cloud instances for the scaling group of the tenant. In this case, the adjusted scaling group includes nine cloud instances, and the current capacity of the adjusted scaling group is 9, reaching the target capacity.

It should be understood that, in this embodiment, an example in which an object to which the cloud management platform is oriented is a tenant is merely used for description, and a type of the object is not limited. In actual application, the object to which the cloud management platform is oriented may alternatively be an internal system (for example, an employee of a cloud vendor) of the cloud vendor, or the like. This is not limited herein.

In embodiments of this application, when the tenant needs to complete auto scaling for the scaling group of the tenant, the cloud management platform may provide the network interface for the tenant, to receive, through the network interface, the auto scaling formula that is for the scaling group and that is input by the tenant. The auto scaling formula includes the variable that indicates the current load of the scaling group, the target load indicator of the scaling group, and the operator, and the variable that indicates the current load of the scaling group, the target load indicator of the scaling group, and the operator are used to determine the target capacity of the scaling group. Then, the cloud management platform may obtain the current load indicator of the scaling group, and substitute the current load indicator of the scaling group into the variable that indicates the current load of the scaling group and that is in the auto scaling formula, to obtain the target capacity of the scaling group. Finally, the cloud management platform may adjust the quantity of cloud instances included in the scaling group, until the capacity of the adjusted scaling group matches the target capacity of the scaling group. In this way, the cloud management platform may automatically complete auto scaling on the scaling group of the tenant according to the auto scaling formula formulated by the tenant. In the foregoing process, the auto scaling formula is formulated by the tenant for the scaling group of the tenant. In other words, content of the auto scaling formula is set by the tenant. Therefore, the cloud management platform determines the target capacity of the scaling group based on the content of the auto scaling formula. This process is determinable for the tenant, that is, the tenant may learn of a reason for auto scaling performed by the cloud management platform for the scaling group and how the cloud management platform performs auto scaling on the scaling group. An auto scaling operation performed by the cloud management platform on the scaling group can be explained to some extent, which can improve trust of the tenant in the entire cloud service system, and equivalently, improve reliability of the entire cloud service system.

Further, in embodiments of this application, the cloud management platform provides a customized network interface for the tenant. The tenant may customize a dedicated auto scaling formula for the scaling group of the tenant based on a requirement of the tenant on quality of service, so that the cloud management platform correspondingly adjusts the capacity of the scaling group based on content of the auto scaling formula. In this way, the capacity of the adjusted scaling group can match quality of service expected by the tenant, thereby improving the quality of service.

The foregoing describes in detail the first case of the method provided in embodiments of this application. The following describes a second case of the method provided in embodiments of this application. FIG. 6 is another schematic flowchart of an auto scaling method based on a cloud management platform according to an embodiment of this application. As shown in FIG. 6, the method may be implemented by the cloud management platform in the cloud service system shown in FIG. 1. The cloud management platform is configured to manage an infrastructure that provides a cloud service, where the infrastructure includes a scaling group created by the cloud management platform for a tenant, and one or more cloud instances included in the scaling group are used to run an application of the tenant. The method includes the following operations.

601: The cloud management platform sends a current load indicator of the scaling group and a current capacity of the scaling group to the tenant through a processing interface provided by the tenant.

602: The cloud management platform receives, through the processing interface, a target capacity that is of the scaling group and that is sent by the tenant, where the target capacity is obtained by the tenant by processing the current load indicator of the scaling group, a target load indicator of the scaling group, and the current capacity of the scaling group according to a preset auto scaling formula.

In this embodiment, when the tenant needs to perform, via the cloud management platform, auto scaling on the scaling group dedicated to the tenant, the tenant may deploy, on a client of the tenant, an auto scaling formula formulated by the tenant for the scaling group, and cause the client to provide the processing interface for the cloud management platform. The auto scaling formula formulated by the tenant for the scaling group may be deployed in the client of the tenant in a form of a plug-in, a processing interface (for example, a representational state transfer (REST) interface) corresponding to the plug-in is configured on the client of the tenant, and the processing interface may be accessed by the cloud management platform.

Because the auto scaling formula formulated by the tenant for the scaling group includes a variable that indicates the current load indicator of the scaling group, the target load indicator of the scaling group, and an operator, the cloud management platform may send the current load indicator of the scaling group and the current capacity of the scaling group to the processing interface provided by the client of the tenant, so that the client of the tenant receives, through the processing interface, the current load indicator of the scaling group and the current capacity of the scaling group that are sent by the cloud management platform.

Then, the client of the tenant may substitute the current load indicator of the scaling group into the variable that indicates the current load indicator and that is in the auto scaling formula, to obtain the target capacity of the scaling group, and send the target capacity of the scaling group to the cloud management platform through the processing interface.

It should be understood that, in this embodiment, for descriptions of the auto scaling formula and a process of calculating the target capacity of the scaling group, refer to related descriptions in the embodiment shown in FIG. 2. Details are not described herein again.

603: The cloud management platform adjusts a quantity of cloud instances included in the scaling group, to obtain an adjusted scaling group, and a capacity of the adjusted scaling group matches the target capacity.

After obtaining the target capacity of the scaling group, the cloud management platform may adjust the quantity of cloud instances included in the scaling group, until the capacity of the adjusted scaling group matches the target capacity of the scaling group. Generally, if a ratio of the current capacity of the scaling group to the target capacity of the scaling group is less than 1, it indicates that the cloud management platform needs to scale up the scaling group, and the cloud management platform adds an additional cloud instance to the scaling group, to obtain the adjusted scaling group. If the ratio of the current capacity of the scaling group to the target capacity of the scaling group is greater than 1, it indicates that the cloud management platform needs to scale down the scaling group, and the cloud management platform reduces a part of cloud instances in the scaling group, to obtain the adjusted scaling group. In this way, the cloud management platform automatically completes auto scaling on the scaling group of the tenant according to the auto scaling formula formulated by the tenant.

In embodiments of this application, the auto scaling formula is formulated by the tenant for the scaling group of the tenant. In other words, content of the auto scaling formula is set by the tenant. Therefore, after the cloud management platform provides data that is of the scaling group and that is required by a policy, a tenant side may determine the target capacity of the scaling group based on the content of the auto scaling formula, and deliver the target capacity of the scaling group to the cloud management platform, so that the cloud management platform completes auto scaling for the scaling group. In this process, the auto scaling formula formulated by the tenant for the scaling group is always retained on the tenant side, and the cloud management platform does not obtain any information related to the auto scaling formula. In this way, on the basis of completing auto scaling on the scaling group via the cloud management platform, confidentiality of the policy formulated by the tenant can be further effectively ensured.

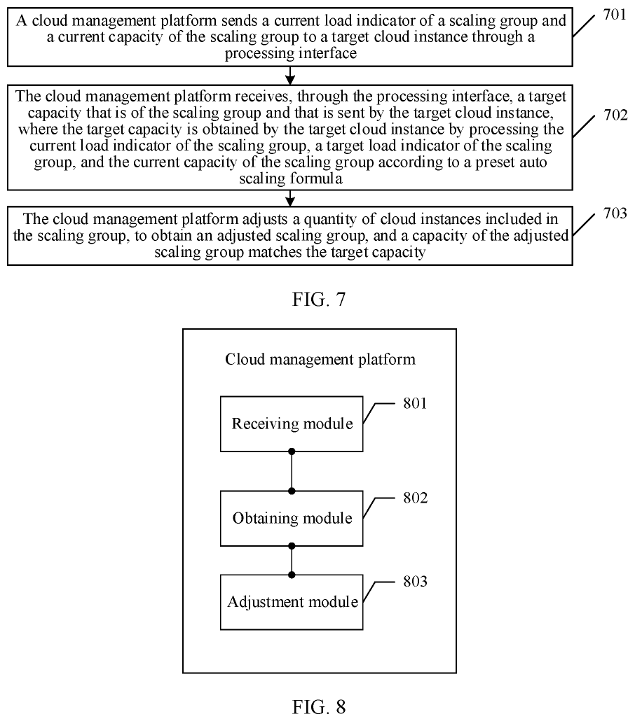

The foregoing describes in detail the second case of the method provided in embodiments of this application. The following describes a third case of the method provided in embodiments of this application. FIG. 7 is still another schematic flowchart of an auto scaling method based on a cloud management platform according to an embodiment of this application. As shown in FIG. 7, the method may be implemented by the cloud management platform in the cloud service system shown in FIG. 1. The cloud management platform is configured to manage an infrastructure that provides a cloud service, where the infrastructure includes a scaling group created by the cloud management platform for a tenant and a target cloud instance. One or more cloud instances included in the scaling group are used to run an application of the tenant, and the target cloud instance includes an auto scaling formula formulated by the tenant for the scaling group and a processing interface. The method includes the following operations.

701: The cloud management platform sends a current load indicator of the scaling group and a current capacity of the scaling group to the target cloud instance through the processing interface.

702: The cloud management platform receives, through the processing interface, a target capacity that is of the scaling group and that is sent by the target cloud instance, where the target capacity is obtained by the target cloud instance by processing the current load indicator of the scaling group, a target load indicator of the scaling group, and the current capacity of the scaling group according to a preset auto scaling formula.

In this embodiment, when the tenant needs to perform, via the cloud management platform, auto scaling on the scaling group dedicated to the tenant, the tenant may cause the cloud management platform to create the dedicated target cloud instance for the tenant, and deploy, in the target cloud instance, the auto scaling formula formulated by the tenant for the scaling group and the processing interface oriented to the cloud management platform. The auto scaling formula formulated by the tenant for the scaling group may be deployed in the target cloud instance in a form of a plug-in, the processing interface (for example, a REST interface) corresponding to the plug-in is configured on the target cloud instance, and the processing interface may be accessed by the cloud management platform. Generally, the target cloud instance of the tenant is isolated (for example, logically isolated or physically isolated) from the scaling group of the tenant.

Because the auto scaling formula formulated by the tenant for the scaling group includes a variable that indicates the current load indicator of the scaling group, the target load indicator of the scaling group, and an operator, the cloud management platform may send the current load indicator of the scaling group and the current capacity of the scaling group to the processing interface provided by the target cloud instance, so that the target cloud instance receives, through the processing interface, the current load indicator of the scaling group and the current capacity of the scaling group that are sent by the cloud management platform.

Then, the target cloud instance may substitute the current load indicator of the scaling group into the variable that indicates the current load indicator and that is in the auto scaling formula, to obtain the target capacity of the scaling group, and send the target capacity of the scaling group to the cloud management platform through the processing interface.

It should be understood that, in this embodiment, for descriptions of the auto scaling formula and a process of calculating the target capacity of the scaling group, refer to related descriptions in the embodiment shown in FIG. 2. Details are not described herein again.

703: The cloud management platform adjusts a quantity of cloud instances included in the scaling group, to obtain an adjusted scaling group, and a capacity of the adjusted scaling group matches the target capacity.

After obtaining the target capacity of the scaling group, the cloud management platform may adjust the quantity of cloud instances included in the scaling group, until the capacity of the adjusted scaling group matches the target capacity of the scaling group. Generally, if a ratio of the current capacity of the scaling group to the target capacity of the scaling group is less than 1, it indicates that the cloud management platform needs to scale up the scaling group, and the cloud management platform adds an additional cloud instance to the scaling group, to obtain the adjusted scaling group. If a ratio of the current capacity of the scaling group to the target capacity of the scaling group is greater than 1, it indicates that the cloud management platform needs to scale down the scaling group, and the cloud management platform reduces a part of cloud instances in the scaling group, to obtain the adjusted scaling group. In this way, the cloud management platform automatically completes auto scaling on the scaling group of the tenant according to the auto scaling formula formulated by the tenant.

In embodiments of this application, the auto scaling formula is formulated by the tenant for the scaling group of the tenant. In other words, content of the auto scaling formula is set by the tenant. Therefore, after the cloud management platform provides data that is of the scaling group and that is required by a policy, the target cloud instance of the tenant may determine the target capacity of the scaling group based on the content of the auto scaling formula, and deliver the target capacity of the scaling group to the cloud management platform, so that the cloud management platform completes auto scaling for the scaling group. In this process, the auto scaling formula formulated by the tenant for the scaling group is always retained in the target cloud instance of the tenant, and the cloud management platform usually does not obtain any information related to the auto scaling formula. In this way, on the basis of completing auto scaling on the scaling group via the cloud management platform, confidentiality of the policy formulated by the tenant can be further ensured to some extent.

The foregoing describes in detail the auto scaling method based on the cloud management platform provided in embodiments of this application. The following describes a cloud management platform provided in embodiments of this application. FIG. 8 is a diagram of a structure of a cloud management platform according to an embodiment of this application. As shown in FIG. 8, the cloud management platform is configured to manage an infrastructure that provides a cloud service, where the infrastructure includes a scaling group of a tenant, and a cloud instance included in the scaling group is used to run an application of the tenant. The cloud management platform includes:
a receiving module 801, configured to receive, through a network interface, an auto scaling formula that is input by a tenant for a scaling group, where the auto scaling formula includes a variable that indicates current load of the scaling group, a target load indicator of the scaling group, and an operator, and the variable, the target load indicator of the scaling group, and the operator are used to determine a target capacity of the scaling group, for example, the receiving module 801 is configured to implement operation 201 in the embodiment shown in FIG. 2;
an obtaining module 802, configured to: obtain a current load indicator of the scaling group, substitute the current load indicator into the variable, and determine the target capacity of the scaling group according to the auto scaling formula, for example, the obtaining module 802 is configured to implement operation 202 in the embodiment shown in FIG. 2; and
an adjustment module 803, configured to adjust the scaling group based on the target capacity, where a capacity of an adjusted scaling group matches the target capacity. For example, the adjustment module 803 is configured to implement operation 203 in the embodiment shown in FIG. 2.

In a possible implementation, the auto scaling formula of the scaling group includes a scale-up formula, and the target capacity of the scaling group is greater than a current capacity of the scaling group.

In a possible implementation, the auto scaling formula of the scaling group includes a scale-down formula, and the target capacity of the scaling group is less than a current capacity of the scaling group.

In a possible implementation, the obtaining module is configured to: obtain the current load indicator of the scaling group, substitute the current load indicator into the variable, to obtain a ratio of the current capacity of the scaling group to the target capacity of the scaling group; and perform calculation based on the current capacity of the scaling group and the ratio, to obtain the target capacity of the scaling group.

In a possible implementation, the current load indicator includes at least one of the following: current usage of a compute resource of a cloud instance in the scaling group, current usage of a storage resource of a cloud instance in the scaling group, current usage of a communication resource of a cloud instance in the scaling group, current request latency of a cloud instance in the scaling group, and a current quantity of requests of a cloud instance in the scaling group; and the target load indicator of the scaling group includes at least one of the following: target usage of a compute resource of a cloud instance in the scaling group, target usage of a storage resource of a cloud instance in the scaling group, target usage of a communication resource of a cloud instance in the scaling group, target request latency of a cloud instance in the scaling group, and a target quantity of requests of a cloud instance in the scaling group.

In a possible implementation, the current capacity of the scaling group includes at least one of the following: a current total quantity of compute resources of a cloud instance in the scaling group, a current total quantity of storage resources of a cloud instance in the scaling group, and a current total quantity of communication resources of a cloud instance in the scaling group; and the target load of the scaling group includes at least one of the following: a target total quantity of compute resources of a cloud instance in the scaling group, a target total quantity of storage resources of a cloud instance in the scaling group, and a target total quantity of communication resources of a cloud instance in the scaling group.

In a possible implementation, the cloud instance in the scaling group is any one of the following: a physical server, a virtual machine, a micro virtual machine, a container, or a bare metal server.

It should be noted that, content such as information exchange between the modules/units of the foregoing apparatus and an implementation process is based on the same concept as the method embodiment of this application, and produces the same technical effects as those of the method embodiment of this application. For example content, refer to the foregoing descriptions in the method embodiment of embodiments of this application. Details are not described herein again.

FIG. 9 is a diagram of a structure of a compute device according to an embodiment of this application. As shown in FIG. 9, the compute device 900 (which may be configured to present the foregoing cloud management platform) includes a processor 901, a memory 902, a communication interface 903, and a bus 904. The processor 901, the memory 902, and the communication interface 903 are coupled through a bus (not marked in the figure). The memory 902 stores instructions. When executable instructions in the memory 902 are executed, the compute device 900 performs the method performed by the cloud management platform in the foregoing method embodiment.

The compute device 900 may be one or more integrated circuits configured to implement the foregoing method, for example, one or more application-specific integrated circuits (ASIC), one or more microprocessors (e.g., digital signal processor (DSP)), one or more field programmable gate arrays (FPGA), or a combination of at least two of these integrated circuit forms. For another example, when units in an apparatus are implemented in a form of scheduling a program by a processing element, the processing element may be a general-purpose processor, for example, a central processing unit (CPU) or another processor that can invoke the program. For still another example, the units may be integrated and implemented in a form of a system-on-a-chip (SoC).

The processor 901 may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or may be any regular processor.

The memory 902 may be a volatile memory or a non-volatile memory, or may include both a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), used as an external cache. Through an example but not limitative description, many forms of RAMs may be used, for example, a static random access memory (static RAM, SRAM), a dynamic random access memory (DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

The memory 902 stores executable program code. The processor 901 executes the executable program code to separately implement functions of the foregoing modules such as the receiving module, the obtaining module, and the adjustment module, to implement the foregoing auto scaling method based on the cloud management platform. In other words, the memory 902 stores instructions for performing the foregoing auto scaling method based on the cloud management platform.

The communication interface 903 uses a transceiver module, for example but not limited to, a network interface card or a transceiver, to implement communication between the compute device 900 and another device or a communication network.

In addition to a data bus, the bus 904 may further include a power bus, a control bus, a status signal bus, and the like. The bus may be a peripheral component interconnect express (PCIe) bus, an extended industry standard architecture (EISA) bus, a unified bus (U bus or UB), a compute express link (CXL), a cache coherent interconnect for accelerators (CCIX), or the like. Buses may be classified into an address bus, a data bus, a control bus, and the like.

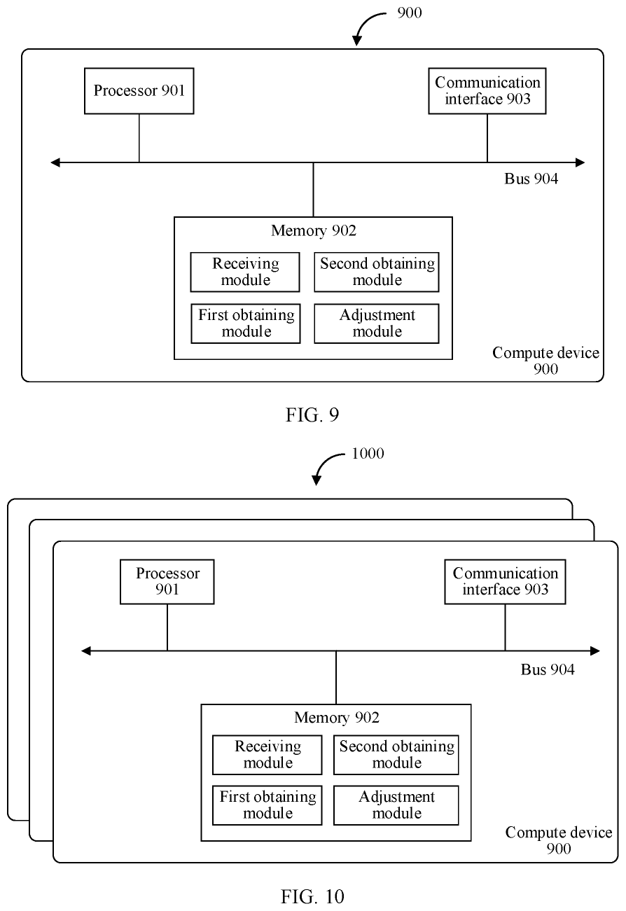

FIG. 10 is a diagram of a structure of a compute device cluster according to an embodiment of this application. As shown in FIG. 10, the compute device cluster 1000 includes at least one compute device 900.

As shown in FIG. 10, the compute device cluster 1000 includes at least one compute device 900. A memory 902 in one or more compute devices 900 in the compute device cluster 1000 may store same instructions for performing the foregoing auto scaling method based on the cloud management platform.

In some possible implementations, the memory 902 in the one or more compute devices 900 in the compute device cluster 1000 may alternatively separately store a part of instructions for performing the foregoing auto scaling method based on the cloud management platform. In other words, a combination of the one or more compute devices 900 may jointly perform the foregoing auto scaling method based on the cloud management platform.

It should be noted that memories 902 in different compute devices 900 in the compute device cluster 1000 may store different instructions, to separately perform a part of functions of the foregoing cloud management platform. In other words, the instructions stored in the memories 902 in different compute devices 900 may implement functions of one or more of modules such as the receiving module, the obtaining module, and the adjustment module.

In some possible implementations, the one or more compute devices 900 in the compute device cluster 1000 may be connected through a network. The network may be a wide area network, a local area network, or the like.

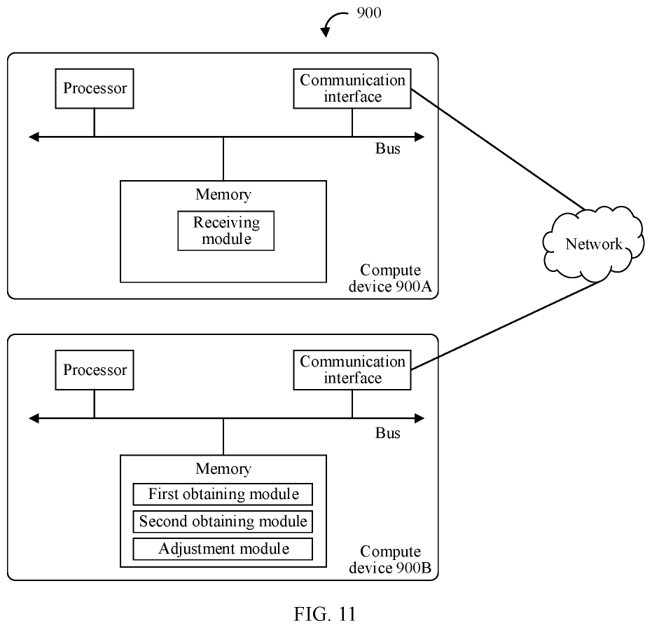

FIG. 11 is a diagram in which computer devices in a computer cluster are connected through a network according to an embodiment of this application. As shown in FIG. 11, a compute device 900A is connected to a compute device 900B through a network. In some embodiments, each compute device is connected to the network through a communication interface in the compute device.

In a possible implementation, a memory in the compute device 900A stores instructions for performing a function of a module like a receiving module, and a memory in the compute device 900B stores instructions for performing functions of modules such as an obtaining module and an adjustment module. Alternatively, a memory in the compute device 900A stores instructions for performing a function of a module like a receiving module, and a memory in the compute device 900B stores instructions for performing a function of a module like an adjustment module. This case is not shown in the figure.

It should be understood that a function of the compute device 900A shown in FIG. 11 may alternatively be completed by a plurality of compute devices. Similarly, a function of the compute device 900B may alternatively be completed by a plurality of compute devices.

An embodiment of this application further relates to a computer storage medium. The computer-readable storage medium stores a program used for signal processing. When the program is run on a computer, the computer is caused to perform the operations performed by the cloud management platform in the embodiment shown in FIG. 2, FIG. 6, or FIG. 7.

An embodiment of this application further relates to a computer program product. The computer program product stores instructions, and when the instructions are executed by a computer, the computer is caused to perform the operations performed by the cloud management platform in the embodiment shown in FIG. 2, FIG. 6, or FIG. 7.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the foregoing apparatus embodiment is merely an example. For example, division into the units is merely logical function division. During actual implementation, another division manner may be used. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to the conventional technology, or all or some of the technical solutions may be implemented in the form of a software product. The computer software product is stored in a storage medium and includes several instructions for enabling a computer device (which may be a personal computer, a server, or a network device) to perform all or some of the operations of the methods described in embodiments of this application. The foregoing storage medium includes any medium that can store program code, such as a USB flash drive, a removable hard disk, a read-only memory (ROM), a random access memory (RAM), a magnetic disk, or an optical disc.

1. An auto scaling method, comprising:
receiving, by a cloud management platform through a network interface, an auto scaling formula that is input by a tenant for a scaling group, wherein the cloud management platform is configured to manage an infrastructure that provides a cloud service, the scaling group of the tenant is disposed in the infrastructure, the auto scaling formula comprises a variable that indicates current load of the scaling group, a target load indicator of the scaling group, and an operator, and the variable, the target load indicator of the scaling group, and the operator are used to determine a target capacity of the scaling group;
obtaining, by the cloud management platform, a current load indicator of the scaling group, substituting the current load indicator into the variable, and determining the target capacity of the scaling group according to the auto scaling formula; and
adjusting, by the cloud management platform, the scaling group based on the target capacity, wherein a capacity of an adjusted scaling group matches the target capacity.

2. The method according to claim 1, wherein the auto scaling formula of the scaling group comprises a scale-up formula, and the target capacity of the scaling group is greater than a current capacity of the scaling group.

3. The method according to claim 1, wherein the auto scaling formula of the scaling group comprises a scale-down formula, and the target capacity of the scaling group is less than a current capacity of the scaling group.

4. The method according to claim 1, wherein the obtaining, by the cloud management platform, the current load indicator of the scaling group, substituting the current load indicator into the variable, and determining the target capacity of the scaling group according to the auto scaling formula comprises:
obtaining, by the cloud management platform, the current load indicator of the scaling group, and substituting the current load indicator into the variable, to obtain a ratio of the current capacity of the scaling group to the target capacity of the scaling group; and
determining, by the cloud management platform, the target capacity of the scaling group based on the current capacity of the scaling group and the ratio.

5. The method according to claim 1, wherein the current load indicator comprises at least one of: current usage of a compute resource of a cloud instance in the scaling group, current usage of a storage resource of a cloud instance in the scaling group, current usage of a communication resource of a cloud instance in the scaling group, current request latency of a cloud instance in the scaling group, or a current quantity of requests of a cloud instance in the scaling group; and
the target load indicator of the scaling group comprises at least one of: target usage of a compute resource of a cloud instance in the scaling group, target usage of a storage resource of a cloud instance in the scaling group, target usage of a communication resource of a cloud instance in the scaling group, target request latency of a cloud instance in the scaling group, or a target quantity of requests of a cloud instance in the scaling group.

6. The method according to claim 1, wherein the current capacity of the scaling group comprises at least one of: a current total quantity of compute resources of a cloud instance in the scaling group, a current total quantity of storage resources of a cloud instance in the scaling group, or a current total quantity of communication resources of a cloud instance in the scaling group; and
the target load of the scaling group comprises at least one of: a target total quantity of compute resources of a cloud instance in the scaling group, a target total quantity of storage resources of a cloud instance in the scaling group, or a target total quantity of communication resources of a cloud instance in the scaling group.

7. The method according to claim 6, wherein the cloud instance in the scaling group is at least one of: a physical server, a virtual machine, a micro virtual machine, a container, or a bare metal server.

8. A compute device cluster, comprising:
a memory to store instructions; and
a processor, operatively coupled to the memory, to:
receive, through a network interface, an auto scaling formula that is input by a tenant for a scaling group, wherein the auto scaling formula comprises a variable that indicates current load of the scaling group, a target load indicator of the scaling group, and an operator, and the variable, the target load indicator of the scaling group, and the operator are used to determine a target capacity of the scaling group;
obtain a current load indicator of the scaling group, substitute the current load indicator into the variable, and determine the target capacity of the scaling group according to the auto scaling formula; and
adjust the scaling group based on the target capacity, wherein a capacity of an adjusted scaling group matches the target capacity.

9. The cluster according to claim 8, wherein the auto scaling formula of the scaling group comprises a scale-up formula, and the target capacity of the scaling group is greater than a current capacity of the scaling group.

10. The cluster according to claim 8, wherein the auto scaling formula of the scaling group comprises a scale-down formula, and the target capacity of the scaling group is less than a current capacity of the scaling group.

11. The cluster according to claim 8, wherein the processor is further to:
obtain the current load indicator of the scaling group, and substitute the current load indicator into the variable, to obtain a ratio of the current capacity of the scaling group to the target capacity of the scaling group; and
perform calculation based on the current capacity of the scaling group and the ratio, to obtain the target capacity of the scaling group.

12. The cluster according to claim 8, wherein the current load indicator comprises at least one of: current usage of a compute resource of a cloud instance in the scaling group, current usage of a storage resource of a cloud instance in the scaling group, current usage of a communication resource of a cloud instance in the scaling group, current request latency of a cloud instance in the scaling group, or a current quantity of requests of a cloud instance in the scaling group; and
the target load indicator of the scaling group comprises at least one: target usage of a compute resource of a cloud instance in the scaling group, target usage of a storage resource of a cloud instance in the scaling group, target usage of a communication resource of a cloud instance in the scaling group, target request latency of a cloud instance in the scaling group, or a target quantity of requests of a cloud instance in the scaling group.

13. The cluster according to claim 8, wherein the current capacity of the scaling group comprises at least one of: a current total quantity of compute resources of a cloud instance in the scaling group, a current total quantity of storage resources of a cloud instance in the scaling group, or a current total quantity of communication resources of a cloud instance in the scaling group; and
the target load of the scaling group comprises at least one of: a target total quantity of compute resources of a cloud instance in the scaling group, a target total quantity of storage resources of a cloud instance in the scaling group, or a target total quantity of communication resources of a cloud instance in the scaling group.

14. The cluster according to claim 813, wherein the cloud instance in the scaling group is at least one of: a physical server, a virtual machine, a micro virtual machine, a container, or a bare metal server.

15. A non-transitory computer-readable storage medium including instructions that, when executed by a computer device, cause the computer device to:
receive, through a network interface, an auto scaling formula that is input by a tenant for a scaling group, wherein the auto scaling formula comprises a variable that indicates current load of the scaling group, a target load indicator of the scaling group, and an operator, and the variable, the target load indicator of the scaling group, and the operator are used to determine a target capacity of the scaling group;
obtain a current load indicator of the scaling group, substitute the current load indicator into the variable, and determine the target capacity of the scaling group according to the auto scaling formula; and
adjust the scaling group based on the target capacity, wherein a capacity of an adjusted scaling group matches the target capacity.

16. The non-transitory computer-readable storage medium according to claim 15,
wherein the auto scaling formula of the scaling group comprises a scale-up formula, and the target capacity of the scaling group is greater than a current capacity of the scaling group.

17. The non-transitory computer-readable storage medium according to claim 15,
wherein the auto scaling formula of the scaling group comprises a scale-down formula, and the target capacity of the scaling group is less than a current capacity of the scaling group.

18. The non-transitory computer-readable storage medium according to claim 15,
comprising further instructions that, when executed by the computer device, cause the computer device to:
obtain the current load indicator of the scaling group, and substitute the current load indicator into the variable, to obtain a ratio of the current capacity of the scaling group to the target capacity of the scaling group; and
perform calculation based on the current capacity of the scaling group and the ratio, to obtain the target capacity of the scaling group.

19. The non-transitory computer-readable storage medium according to claim 15, wherein the current load indicator comprises at least one of: current usage of a compute resource of a cloud instance in the scaling group, current usage of a storage resource of a cloud instance in the scaling group, current usage of a communication resource of a cloud instance in the scaling group, current request latency of a cloud instance in the scaling group, or a current quantity of requests of a cloud instance in the scaling group; and
the target load indicator of the scaling group comprises at least one: target usage of a compute resource of a cloud instance in the scaling group, target usage of a storage resource of a cloud instance in the scaling group, target usage of a communication resource of a cloud instance in the scaling group, target request latency of a cloud instance in the scaling group, or a target quantity of requests of a cloud instance in the scaling group.

20. The non-transitory computer-readable storage medium according to claim 15, wherein the current capacity of the scaling group comprises at least one of: a current total quantity of compute resources of a cloud instance in the scaling group, a current total quantity of storage resources of a cloud instance in the scaling group, or a current total quantity of communication resources of a cloud instance in the scaling group; and
the target load of the scaling group comprises at least one of: a target total quantity of compute resources of a cloud instance in the scaling group, a target total quantity of storage resources of a cloud instance in the scaling group, or a target total quantity of communication resources of a cloud instance in the scaling group.
